(19) United States
(12) Patent Application Publication
(10) Pub. No.: US 2024/0154661 A1
(43) Pub. Date: May 9, 2024

(54) UNSCENTED KALMAN FILTER-BASED BEAM TRACKING SYSTEM AND METHOD THEREOF

(71) Applicant: INDUSTRY FOUNDATION OF CHONNAM NATIONAL UNIVERSITY, Gwangju (KR)

(72) Inventors: Yuna SIM, Gwangju (KR); Seungseok SIN, Gwangju (KR); Intae HWANG, Seoul (KR)

(73) Assignee: INDUSTRY FOUNDATION OF CHONNAM NATIONAL UNIVERSITY, Gwangju (KR)

(21) Appl. No.: 18/305,392

(22) Filed: Apr. 24, 2023

(30) Foreign Application Priority Data
Nov. 4, 2022 (KR) 10-2022-0145906

(51) Int. Cl. H04B 7/06; G01S 5/02; H04B 7/185; H04W 16/28

(52) U.S. Cl. CPC H04B 7/0617; G01S 5/0294; H04B 7/18502; H04W 16/28; G01S 2205/03

(57) ABSTRACT

An unscented Kalman filter-based beam tracking system and a method thereof are proposed. The system includes a base station for performing beamforming to an unmanned aerial vehicle, and the base station includes a pre-processing unit for deriving an expected vector value for a movement trajectory of the UAV with a signal received from the UAV and selecting at least one sigma point from the derived expected vector value, a covariance derivation unit for deriving an autocovariance by inputting the selected sigma point to a nonlinear measurement function and deriving a cross-covariance with the derived expected vector value and the derived autocovariance, and a beam estimation unit for deriving a beamforming angle for a future movement trajectory of the UAV by deriving an unscented Kalman filter gain from the derived autocovariance and derived cross-covariance, thereby having effects of a low mean square error, high spectral efficiency, high accuracy of beam tracking.

### CROSS REFERENCE TO RELATED APPLICATION

The present application claims priority to Korean Patent Application No. 10-2022-0145906, filed Nov. 4, 2022, the entire contents of which is incorporated herein for all purposes by this reference.

### BACKGROUND OF THE INVENTION

### Field of the Invention

The present disclosure relates to an unscented Kalman filter-based beam tracking system and a method thereof and, more particularly, to a technology capable of improving transmission traffic of data transmitted to an unmanned aerial vehicle in a 5G and Below 6G (B6G) environments.

### Description of the Related Art

In a New Radio Multiple-Input Multiple-Output Orthogonal Frequency-Division Multiplexing (NR MIMO-OFDM) environment, Unmanned Aerial Vehicles (UAVs) have capability to overcome limitations of terrestrial networks due to the UAVs having characteristics of high altitude, flexibility, and mobility, thereby attracting attention as one of the key elements of the 5G NR environment.

Currently, various types of UAVs are being utilized in many situations. For example, when a high-altitude UAV platform is used, a range of serviceable radio areas may be expanded. Meanwhile, when a relatively low-altitude platform is used, time-sensitive environments may be easily accessed.

In addition, in hot-spot areas where network usage increases rapidly, when UAVs are used as base stations (BSs) to increase data capacity, the problem of explosively increasing data traffic may be solved. Massive Multiple-Input Multiple-Output (MIMO) technology, which uses multiple antennas to increase data transmission/reception efficiency, may also support high data rates in the NR MIMO-OFDM environments.

In the case of conventional millimeter waves, a short wavelength due to a high frequency causes problems such as signal attenuation and path loss, and thus, in order to resolve such a problem, interest in research on high directivity beamforming technology is growing. In this case, when acquiring full beamforming gains and considering high mobility of UAVs, it is essential to obtain accurate beam angles.

### DOCUMENTS OF RELATED ART

### Patent Documents

(Patent Document 1) Korea Patent No. 10-1869224 (Jun. 20, 2018)

### SUMMARY OF THE INVENTION

The present disclosure may provide an unscented Kalman filter-based beam tracking system and a method thereof capable of estimating an accurate beam angle in an NR MIMO-OFDM environment and accurately estimating the beam angle with high spectral efficiency.

According to one aspect of the present disclosure, there is provided an unscented Kalman filter-based beam tracking system, including: a base station for performing beamforming to an unmanned aerial vehicle, wherein the base station includes: a pre-processing unit configured to derive an expected vector value for a movement trajectory of the unmanned aerial vehicle with a signal received from the unmanned aerial vehicle, and select at least one sigma point from the derived expected vector value; a covariance derivation unit configured to derive an autocovariance by inputting the selected sigma point to a nonlinear measurement function, and derive a cross-covariance with the derived expected vector value and the derived autocovariance; and a beam estimation unit configured to derive a beamforming angle for a future movement trajectory of the unmanned aerial vehicle by deriving an unscented Kalman filter gain from the derived autocovariance and the derived cross-covariance.

Preferably, the vector value may be a channel angle vector of the signal received from a location of the unmanned aerial vehicle.

Preferably, the pre-processing unit may derive a next vector value from a previous vector value on the basis of a time at which the signal is received.

Preferably, the covariance derivation unit may derive a Gaussian distribution for the vector value and derive the movement trajectory of the unmanned aerial vehicle with the derived Gaussian distribution.

Preferably, the beam estimation unit may re-derive the vector value with the derived unscented Kalman filter gain.

According to another aspect of the present disclosure, there is provided an unscented Kalman filter-based beam tracking method, including: a preprocessing step of deriving an expected vector value for a movement trajectory of an unmanned aerial vehicle with a signal received from the unmanned aerial vehicle, and selecting at least one sigma point from the derived expected vector value; a covariance derivation step of deriving an autocovariance by inputting the selected sigma point to a nonlinear measurement function, and deriving a cross-covariance with the derived expected vector value and the derived autocovariance; and a beam estimation step of deriving a beamforming angle for a future movement trajectory of the unmanned aerial vehicle by deriving an unscented Kalman filter gain from the derived autocovariance and the derived cross-covariance and re-deriving the vector value with the derived gain of the unscented Kalman filter.

Preferably, in the pre-processing step, a next vector value may be derived from a previous vector value on the basis of a time at which the signal is received.

Preferably, in the covariance derivation step, a Gaussian distribution for the vector value may be derived and the movement trajectory of the unmanned aerial vehicle is derived with the derived Gaussian distribution.

According to the present disclosure, there are effects that a low mean square error and high spectral efficiency may be provided and high accuracy of beam tracking may be improved in a mobile communication environment.

### BRIEF DESCRIPTION OF THE DRAWINGS

FIG. 1 is a configuration view of a beam tracking system according to an exemplary embodiment.

FIG. 2 is a view illustrating a uniform planar antenna array on a transmission/reception side according to the exemplary embodiment.

FIG. 3 is a view illustrating a hybrid precoding structure according to the exemplary embodiment.

FIG. 4 is a flowchart illustrating a UKF-based beam tracking algorithm using hybrid beamforming according to the exemplary embodiment.

FIG. 5 is a graph illustrating mean square error performance of beam tracking for each type of beamforming according to the exemplary embodiment.

FIG. 6 is a graph illustrating mean square error performance of beam tracking by number of RF chains according to the exemplary embodiment.

FIG. 7 is a graph illustrating mean square error performance of beam tracking for each SNR according to the exemplary embodiment.

FIG. 8 is a graph illustrating mean square error performance of beam tracking for each channel angular dispersion according to the exemplary embodiment.

FIG. 9 is a graph illustrating frame error rate performance of beam tracking for each type of beamforming according to the exemplary embodiment.

FIG. 10 is a graph illustrating transmission throughput performance of beam tracking for each type of beamforming according to the exemplary embodiment.

FIG. 11 is a graph illustrating spectral efficiency performance of beam tracking for each type of beamforming according to the exemplary embodiment.

FIG. 12 is a flowchart illustrating a beam tracking method according to an exemplary embodiment.

### DETAILED DESCRIPTION OF THE INVENTION

Hereinafter, an unscented Kalman filter-based beam tracking system and a method thereof according to the present disclosure will be described in detail with reference to the accompanying drawings. In this process, the thickness of the lines or the size of components shown in the drawings may be exaggerated for clarity and convenience of description. In addition, terms to be described later are terms defined in consideration of functions in the present disclosure and may vary according to the intentions or practices of the operators. Therefore, definitions of these teams should be made based on the contents throughout the present specification.

Objectives and effects of the present disclosure may be naturally understood or more clearly understood by the following description, and the objectives and effects of the present disclosure are not limited only by the following description. In addition, in describing the present disclosure, when it is determined that a detailed description of a known technology related to the present disclosure may unnecessarily obscure the subject matter of the present disclosure, the detailed description thereof will be omitted.

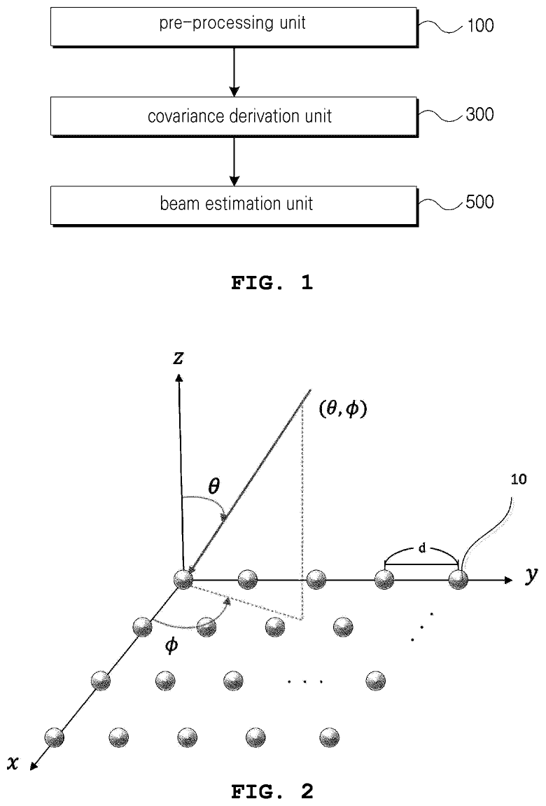

FIG. 1 is a configuration view of a beam tracking system according to an exemplary embodiment.

As shown in FIG. 1, a configuration of the beam tracking system according to the exemplary embodiment includes a base station for conducting beamforming with an unmanned aerial vehicle, and the base station includes a pre-processing unit 100, a covariance derivation unit 300, and a beam estimation unit 500.

The pre-processing unit 100 derives an expected vector value for a movement trajectory of an unmanned aerial vehicle with a signal received from the unmanned aerial vehicle, and selects at least one sigma point from the derived expected vector value. Here, the vector value may be a channel angle vector of a signal received from a location of the unmanned aerial vehicle. In addition, the pre-processing unit 100 may derive an expected covariance for the movement trajectory of the unmanned aerial vehicle. The sigma point may be derived from the expected vector value and the expected covariance. In addition, the pre-processing unit 100 may derive a next vector value from a previous vector value on the basis of a time at which the signal is received.

The covariance derivation unit 300 derives an autocovariance by inputting the selected sigma point to a nonlinear measurement function, and derives a cross-covariance with the derived expected vector value and the derived autocovariance. Here, the covariance derivation unit 300 may derive a Gaussian distribution for the vector value and derive a movement trajectory of the unmanned aerial vehicle with the derived Gaussian distribution.

The beam estimation unit 500 derives an unscented Kalman filter gain from the derived autocovariance and the derived cross-covariance to derive a beamforming angle for a future movement trajectory of the unmanned aerial vehicle. In addition, the beam estimation unit 500 may re-derive the vector value with the derived unscented Kalman filter gain.

FIG. 2 is a view illustrating a uniform planar antenna array on a transmission/reception side according to the exemplary embodiment.

As shown in FIG. 2, a downlink UAV-supported NR MIMO-OFDM system in which one Unmanned Aerial Vehicle-Base Station (UAV-BS) serves one Ground-User Equipment (G-UE) may be considered. Both of a UAV-BS at the transmission side and a G-UE at the reception side may be provided with an array of antennas 10 in a form of a Uniform Planar Array (UPA) evenly arranged on a xy plane. The UAV-BS may be provided with an array of UPA antennas 10 of Mₜ×Nₜ, and the G-UE may be provided with an array of UPA antennas 10 of Mᵣ×Nᵣ. Each distance between adjacent antennas 10 is d(=λ/2), d=d_{H}=d_{V}, and a uniform size of each distance is provided as d_{H} in a horizontal axis direction and d_{V} in a vertical axis direction. Here, λ denotes a wavelength of a carrier wave.

A zenith angle and an azimuth angle at a transmitter are respectively expressed by λ (Zenith angle of Departure, ZOD) and ϕₜ (Azimuth angle of Departure, AOD), and a zenith angle and an azimuth angle at a receiver are respectively expressed by θᵣ (Zenith angle of Arrival, ZOA) and ϕᵣ (Azimuth angle of Arrival, AOA). In this case, the angle notation follows the definition specified in 3GPP TR 38.901 v16.1.0.

When beamformer and combiner vectors are respectively denoted as vₖ(vₖ∈C^{M}^{ₜ}^{N}^{ₜ}^{×1}) and wₖ(wₖ∈C^{M}^{ᵣ}^{N}^{ᵣ}^{×1}), and when a transmission signal xₖ is transmitted, a received signal may be expressed by the following equation.

yₖ=wₖ^{H}hₖ^{H}vₖxₖ+nₖ [Equation 1]

In Equation 1, hₖ(hₖ∈C [symbol] ) may represent a 3D channel used between the UAV-BS and the G-UE in a k^{th} Transmission Time Interval (TTI). nₖ is additive white Gaussian noise that is applied at k^{th} TTI and follows a normal distribution nₖ˜N(0,σₙ²).

In the NR MIMO-OFDM communication environment, a channel model in which a channel does not change within one TTI but the channel changes between TTIs is considered. In most of mmWave frequency signals, signal loss occurs due to obstacles such as buildings and people. As a result, most of signal power reaching the G-UE from the UAV-BS arrives through a Line of Sight (LoS) path. Accordingly, in the UAV-supported NR MIMO-OFDM environment, merely the LoS path is considered. When a response vector (a(θ_{l,k},ϕ_{l,k})) of the array of antennas 10 is applied at the transmission side and the reception side, a channel vector may be expressed by the following equation.

hₖ=η_{l,k}aᵣ^{H}(θ_{l,k}^{r},ϕ_{l,k}^{r})aₜ(θ_{l,k}^{t},ϕ_{l,k}^{t}) [Equation 2]

In Equation 2, η_{l,k} denotes a path gain, which can be calculated by the following equation.

$$\\ \begin{matrix}{η}_{l , k} = {ρ}_{l , k} \sqrt{{M}_{r} {N}_{r} {M}_{t} {N}_{t}} {e}^{{}^{} - j \frac{2 π d}{λ}} & [ Equation 3 ]\end{matrix}$$

In Equation 3, ρ_{l,k} denotes a degree of signal attenuation, and d denotes a distance between adjacent antennas 10. In both of the transmitter and receiver, a response vector of the array of antennas 10 having a uniform square planar array configuration may be modeled by the following equation.

$$\\ \begin{matrix}a ( θ , ϕ ) = \frac{1}{\sqrt{MN}} {( [ \begin{matrix}1 , … , {e}^{{}^{} jkd ( m sin ( θ ) sin ( ϕ ) + n sin ( θ ) cos ( ϕ ) )} , … , \\ {e}^{{}^{} jkd ( ( M - 1 ) sin ( θ ) sin ( ϕ ) + ( N - 1 ) sin ( θ ) cos ( ϕ ) )}\end{matrix} ] )}^{T} & [ Equation 4 ]\end{matrix}$$

In Equation 4, m(0<m<M−1) and n(0<n<N−1) denote index elements of antennas 10 of the respective horizontal axis and vertical axis in the array of antennas 10, and the total number of antennas 10 is MN.

In order to maximally increase the beam tracking performance, a case of using analog beamforming and a case of using hybrid beamforming may be compared and analyzed with each other. In this case, as performance indicators, Mean Square Error (MSE), Frame Error Rate (FER), Throughput, and Spectral Efficiency (SE) are used. All the performance indicators are based on AOD, and the case of MSE may be calculated by the following equation.

MSE=E[|ϕₖ^{t}−\hat{ϕ}ₖ^{t}|²] [Equation 5]

Beamforming is a technology that arranges several antennas 10 at predetermined distances and changes an amplitude and phase of a signal supplied through each antenna 10 so as to generate a beam of each antenna 10 in a specific direction, thereby enabling strong transmission and reception of the signal. In particular, in a case of a 5G environment using a millimeter wave frequency, i.e., a high-frequency, a wavelength is reduced, so a separation distance between each antenna 10 may be short, thereby enabling the implementation of massive MIMO technology that integrates the antennas 10 at high density. Accordingly, in the present NR MIMO-OFDM environment, when the beamforming technology is applied through the array of square planar antennas 10, the cell coverage may be expanded and the transmission speed may be increased.

The beamforming technology is divided into three types, including analog beamforming, fully digital beamforming, and hybrid beamforming using a combination thereof.

The analog beamforming is a method of applying a beamformer to a Radio Frequency (RF) end. In this method, implementation complexity is a relatively low, but there are weak points that the implementation of an arbitrary beamforming matrix is difficult and limited to one user and one transmission/reception flow.

In the case of fully digital beamforming, a beamformer is applied to a baseband. In this case, since beamforming may be applied by allocating different frequency resources to respective users in a cell, the beamforming for several users is enabled at the same time. In addition, since an arbitrary beamforming matrix is implemented by using digital signal processing, the controlling of power as well as interference between users are convenient. However, the implementation of this method has weak points that many hardware resources are required and processing complexity is high. Accordingly, the hybrid beamforming is considered, wherein beamformers are applied to both of the RF end and the baseband, in other words, the analog beamforming and the fully digital beamforming are simultaneously applied.

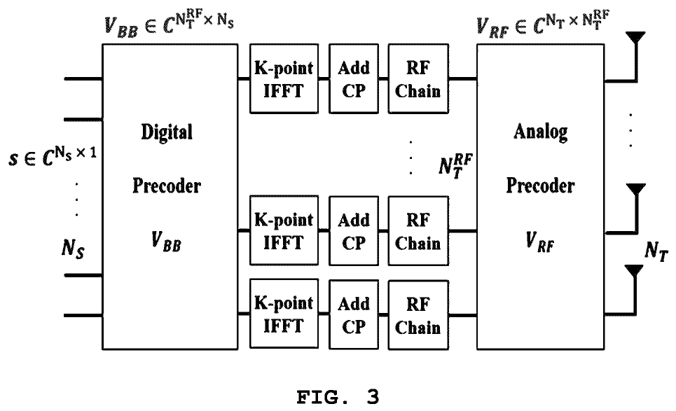

FIG. 3 is a view illustrating a hybrid precoding structure according to the exemplary embodiment.

As shown in FIG. 3, digital precoding is performed on a data symbol of N [symbol] by using V_{BB}(V_{BB}∈C [symbol] ) in the transmitter. Then, after converting the data symbol to a time axis through K-point IFFT, a Cyclic Prefix (CP) is inserted thereto. Further, after analog precoding is applied using V_{RF}(V_{RF}∈C^{N}^{_{T}}^{×N}^{_{T}}^{^{RF}}), the applied result may be transmitted to a channel. In the UFK-based beam tracking method, a channel angle vector is expressed as in the following equation, and is defined as a state vector for convenience.

ψₖ=[θₖ^{t}ϕₖ^{t}θₖ^{r}ϕₖ^{r}]^{T} [Equation 6]

In Equation 6, a state vector transition equation follows the equation below.

ψₖ=ψₖ₋₁+qₖ [Equation 7]

In Equation 7, qₖ(qₖ∈N^{4×4}) represents Gaussian noise, qₖ follows a normal distribution of N(0,Q), and Q(Q=σ²I₄) is a 4×4 matrix of channel angular dispersion σ² representing how fast the channel changes. Actual channel angular dispersion differs according to ZOD(θₖ^{t}), AOD(ϕₖ^{t}), ZOA(θₖ^{r}), and AOA(ϕₖ^{r}), but is assumed to be the same value for computational convenience. A signal received in a UKF-based beam tracking method may be expressed by the following equation.

$$\\ \begin{matrix}\begin{matrix}{y}_{k} = {w}_{k}^{{}^{} H} {h}_{k}^{{}^{} H} {v}_{k} {x}_{k} + {n}_{k} \\ = {η}_{k} {w}_{k}^{{}^{} H} {a}_{r} ( {θ}_{k}^{{}^{} r} , {ϕ}_{k}^{{}^{} r} ) {a}_{i}^{{}^{} H} ( {θ}_{k}^{{}^{} t} , {ϕ}_{k}^{{}^{} t} ) {v}_{k} {x}_{k} + {n}_{k}\end{matrix} & [ Equation 8 ]\end{matrix}$$

In Equation 8, in this case, since yₖ and nₖ are complex forms, they can be redefined as the following equation.

$$\\ \begin{matrix}{y}_{k} = [ \begin{matrix}Re ( {y}_{k} ) \\ Im ( {y}_{k} )\end{matrix} ] = [ \begin{matrix}Re ( {w}_{k}^{{}^{} H} {h}_{k}^{{}^{} H} {v}_{k} {x}_{k} + {n}_{k} ) \\ Im ( {w}_{k}^{{}^{} H} {h}_{k}^{{}^{} H} {v}_{k} {x}_{k} + {n}_{k} )\end{matrix} ] & [ Equation 9 ]\end{matrix}$$

$$\\ \begin{matrix}{n}_{k} = {[ Re ( {n}_{k} ) Im ( {n}_{k} ) ]}^{T} & [ Equation 10 ]\end{matrix}$$

$$\\ {n}_{k} \sim N ( 0 , {Q}_{n} )$$

$$\\ {Q}_{n} = \frac{{σ}_{n}^{{}^{} 2}}{2} {I}_{2}$$

In addition, in Equations 9 and 10, a nonlinear measurement function can be expressed as ƒ(ψₖ) and g(ψₖ) as shown in the following equation.

ƒ(ψₖ)=Re(wₖ^{H}hₖ^{H}vₖxₖ)

g(ψₖ)=Im(wₖ^{H}hₖ^{H}vₖxₖ) [Equation 11]

An initial state vector and covariance can be expressed by the following Equations 12 and 13.

\hat{ψ}₀E[ψ] [Equation 12]

P₀=E[(ψ−\hat{ψ}₀)(ψ−\hat{ψ}₀)^{T}] [Equation 13]

To predict a next state vector, a state vector of a previous (k−1)^{th} is used. Accordingly, the state vector and covariance can be predicted by the following equations, respectively.

\hat{ψ}ₖ^{ƒ}=\hat{ψ}ₖ₋₁ [Equation 14]

P̅ₖ=Pₖ₋₁+Q_{g} [Equation 15]

In Equations 14 and 15, k denotes a state index, which is an integer greater than or equal to 1.

The UKF-based beam tracking method is a method of substituting several sample points called sigma points into the nonlinear measurement function, so as to estimate a motion state of a UAV with a Gaussian distribution, thereby tracking an angle.

ψ̅ₖ=[ψ̅ₖ⁰ψ̅ₖ¹ . . . ψ̅ₖ²ⁿ] [Equation 16]

In Equation 16, ψ̅ₖ denotes 2n+1 sigma points, where a value n is 4, which is a dimension of the state vector, as shown in Equation 6. Each element of ψ̅ₖ can be calculated through the following equation.

$$\\ \begin{matrix}\begin{matrix}\overline{ψ} {}_{k}^{{}^{} 0} = \hat{ψ} {}_{k}^{{}^{} f} \\ \overline{ψ} {}_{k}^{{}^{} i} = \hat{ψ} {}_{k}^{{}^{} f} + {γ ( \sqrt{{\overline{P}}_{k}} )}_{( i )} , i = 1 , … , n , \\ \overline{ψ} {}_{k}^{{}^{} i} = \hat{ψ} {}_{k}^{{}^{} f} - {γ ( \sqrt{{\overline{P}}_{k}} )}_{( i )} , i = n + 1 , … , 2 n\end{matrix} & [ Equation 17 ]\end{matrix}$$

$$\\ \begin{matrix}\begin{matrix}ϒ = \sqrt{n + s} \\ s = {α}^{2} ( n + κ ) - n\end{matrix} & [ Equation 18 ]\end{matrix}$$

$$\\ \begin{matrix}{Z}_{k}^{{}^{} i} = {[ f ( {\overline{ψ}}_{k} ) g ( {\overline{ψ}}_{k} ) ]}^{T} , i = 0 , … , 2 n & [ Equation 19 ]\end{matrix}$$

In Equation 17, (\sqrt{P̅ₖ})₍ᵢ₎ denotes an i-th column vector of a matrix shown in Equation 15, and weights in Equation 17 can be respectively calculated through Equation 18. Here, s denotes a scaling variable, and α is a constant representing the spread of sigma points around a predicted state vector (\hat{ψ}ₖ^{ƒ}). Here, α is usually set to a small positive value within a range of 10⁻⁴≤α≤1, but is calculated as 10⁻³. The constant K denotes a second-order scaling variable and can be calculated as 3−n.

In Equation 19, the previously calculated sigma points can be substituted into the nonlinear measurement function, and the result can be expressed as Zₖ(Zₖ=[Zₖ⁰Zₖ¹ . . . Zₖ²ⁿ⁺¹]^{T}). A state vector and an autocovariance can be estimated by using an output value (Zₖⁱ) of the nonlinear measurement function and estimating the Gaussian distribution.

$$\\ \begin{matrix}{\hat{Z}}_{k} = {\sum }_{i = 0}^{2 n} {W}_{i}^{{}^{} m} {Z}_{k}^{{}^{} i} & [ Equation 20 ]\end{matrix}$$

$$\\ \begin{matrix}{P}_{( ZZ ) k} = {\sum }_{i = 0}^{2 n} {W}_{i}^{{}^{} c} {[ {Z}_{k}^{{}^{} i} - {\hat{Z}}_{k} ] [ {Z}_{k}^{{}^{} i} - {\hat{Z}}_{k} ]}^{T} + {Q}_{n} & [ Equation 21 ]\end{matrix}$$

$$\\ \begin{matrix}\begin{matrix}{W}_{0}^{{}^{} m} = \frac{s}{n + s} , \\ {W}_{0}^{{}^{} c} = \frac{s}{n + s} + ( 1 - {α}^{{}^{} 2} + β ) , \\ {W}_{i}^{{}^{} m} = {W}_{i}^{{}^{} c} = \frac{s}{2 ( n + s )} , i = 1 , … , 2 n\end{matrix} & [ Equation 22 ]\end{matrix}$$

Equation 20 expresses a process of estimating a state vector, Equation 21 expresses a process of estimating an autocovariance, and Equation 22 expresses weights used in respective calculation processes. Here, β is a value indicating a degree of inclusion of previous information when estimating a distribution of a state vector ψ, and can be set to 2 because a shape of the estimated distribution follows the Gaussian distribution.

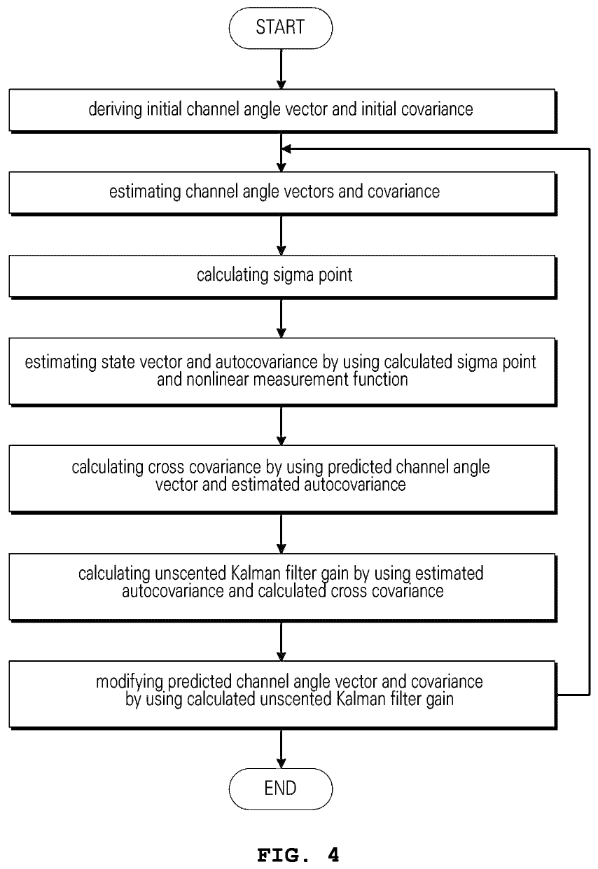

FIG. 4 is a flowchart illustrating a UKF-based beam tracking algorithm using the hybrid beamforming according to the exemplary embodiment.

As shown in FIG. 4, since a motion of a UAV follows a very nonlinear model in the case of a UAV-supported environment, a method of tracking a beam angle by using UKF will be described in detail.

A cross-covariance between the state vector \hat{ψ}ₖ^{ƒ} previously predicted through Equation 14 and the state vector \hat{Z}ₖ estimated through Equation 20 can be calculated using the following equation.

$$\\ \begin{matrix}{P}_{( XZ ) k} = {\sum }_{i = 0}^{2 n} {{W}_{i}^{{}^{} c} [ \overline{ψ} {}_{k}^{{}^{} i} - \hat{ψ} {}_{k}^{{}^{} i} ] [ {Z}_{k}^{{}^{} i} - {\hat{Z}}_{k} ]}^{T} & [ Equation 23 ]\end{matrix}$$

With the previously calculated autocovariance P_{(ZZ)k} and cross-covariance P_{(XZ)k}, a UKF Kalman gain εₖ can be calculated using the following equation.

εₖ=P_{(XZ)k}P_{(ZZ)k}⁻¹ [Equation 24]

In Equation 24, the above-described state vector \hat{ψ}ₖ^{ƒ} and covariance P̅ₖ respectively predicted in Equations 14 and 15 can be modified using the calculated Kalman gain value and be expressed as the following equation.

\hat{ψ}ₖ=\hat{ψ}ₖ^{ƒ}+εₖ[Zₖ−\hat{Z}ₖ] [Equation 25]

Pₖ=P̅ₖ−εₖP_{(ZZ)k}εₖ^{T} [Equation 26]

In Equation 25, \hat{ψ}ₖ is a final estimate of a current channel angle vector, and in Equation 26, Pₖ is a final covariance of the channel angle vector. Both values are used for beam tracking in the next state. The UKF-based beam tracking method is shown in FIG. 4.

### Simulation Environment and Performance Analysis

### Simulation Environment

Table 1 below shows simulation system parameters, and simulation is performed based on the NR downlink UAV-supported NR MIMO-OFDM system. A system was configured to have a system bandwidth of 100 MHz in a frequency band of 30 GHz.

TABLE 1

| Parameter | Value |
|---|---|
| Frequency band (GHz) | 30 |
| System bandwidth (MHz) | 100 |
| Sub-Carrier Spacing (kHz) | 60 |
| Cyclic Prefix | Normal CP |
| Modulation/demodulation method | QPSK |
| UAV-BS antenna configuration | UPA: 16 × 16 |
| G-UE antenna configuration | UPA: 4 × 4 |
| Number of RF chains | 8/16 |
| Antenna distance (wavelength, λ) | 0.5 |
| Initial ZOD/AOD/ZOA/AOA | π/4 |
| Number of streams | 1 |

### Simulation Performance Analysis

In order to evaluate the performance improvement of the proposed technique, the case where the analog beamforming is used and the case where the hybrid beamforming is used are compared and analyzed with each other.

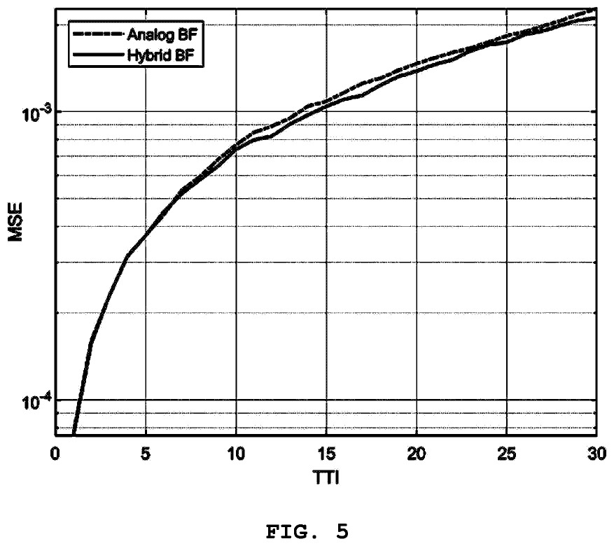

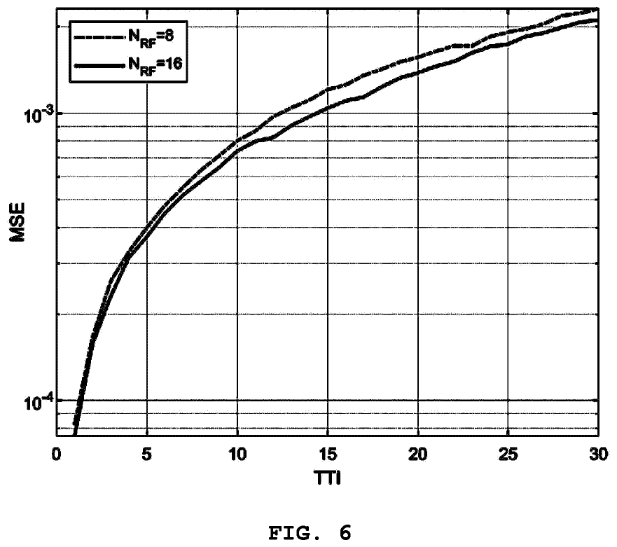

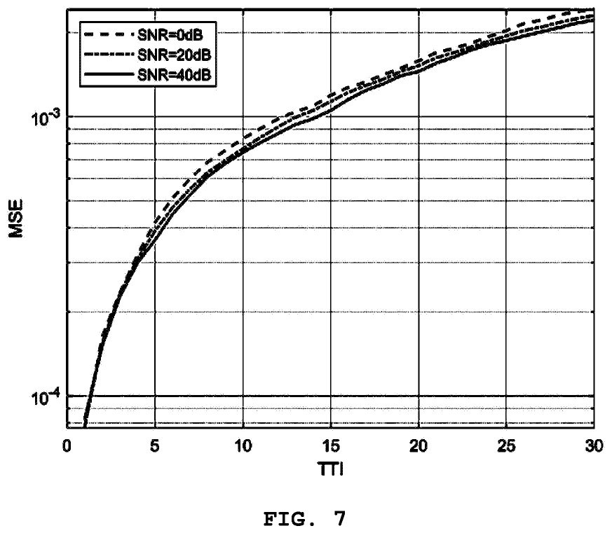

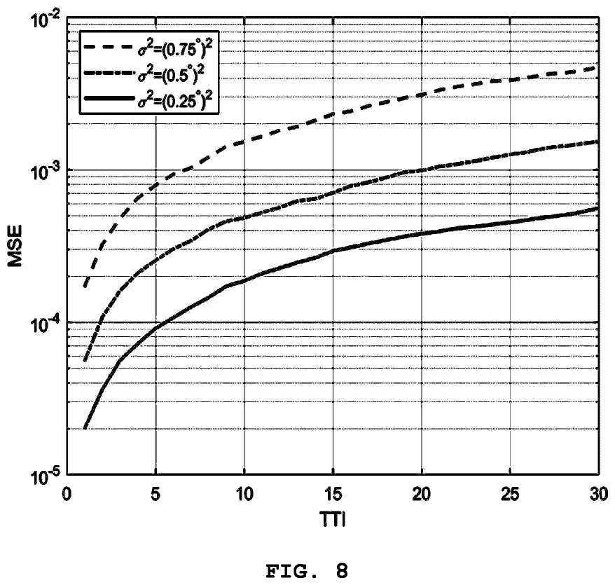

FIG. 5 is a graph illustrating mean square error performance of beam tracking for each type of beamforming according to the exemplary embodiment. FIG. 6 is a graph illustrating mean square error performance of beam tracking by number of RF chains according to the exemplary embodiment. FIG. 7 is a graph illustrating mean square error performance of beam tracking for each SNR according to the exemplary embodiment. FIG. 8 is a graph illustrating mean square error performance of beam tracking for each channel angular dispersion according to the exemplary embodiment.

As shown in FIGS. 5 to 8, the simulation results of comparing MSE performance according to the beamforming technique in FIG. 5 show that when the UKF-based beam tracking is performed using the hybrid beamforming, the MSE performance is further improved compared to that of using the analog beamforming.

In addition, as shown in the simulation results in FIG. 6 comparing the MSE performance according to the number of RF chains when the hybrid beamforming was used, the simulations were performed in cases where the number of RF chains was 8 and 16, respectively, and thus it may be confirmed that the performance is further improved in the case of 16. Then, subsequently, a simulation is conducted in a condition where the hybrid beamforming is used and the number of RF chains that is set to 16.

As shown in the results of analyzing the MSE performance of the UKF-based beam tracking algorithm using the hybrid beamforming at SNRs different from each other in FIG. 7, it may be confirmed that the MSE value of the estimated AOD gradually decreases as the SNRs increase. In this case, the channel angle dispersion σ² is set to (0.5′)², and the simulation is conducted.

As shown in the simulation results of analyzing the MSE performance of the proposed algorithm according to the channel angle dispersion σ² in FIG. 8, the channel changes rapidly as the value of the channel angle dispersion increases, and beam tracking based on UKF becomes difficult. Accordingly, the MSE of the AOD also increases. In this case, the SNR is set to 20 dB.

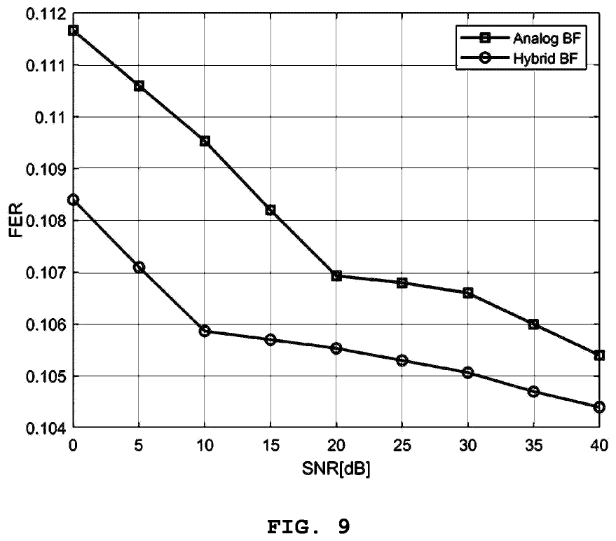

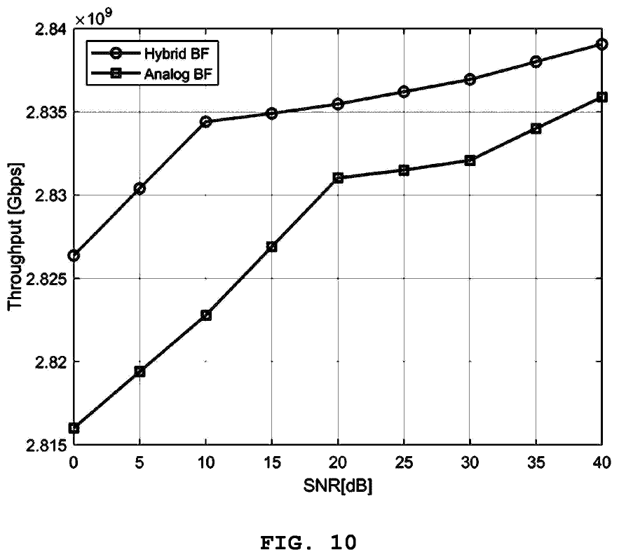

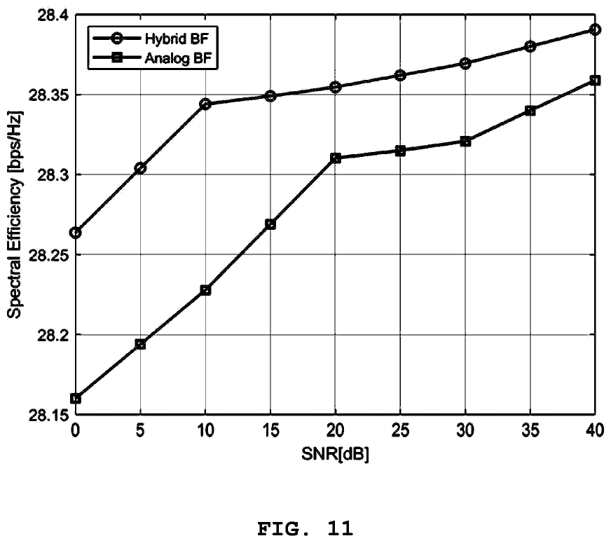

FIG. 9 is a graph illustrating frame error rate performance of beam tracking for each type of beamforming according to the exemplary embodiment. FIG. 10 is a graph illustrating transmission throughput performance of beam tracking for each type of beamforming according to the exemplary embodiment. FIG. 11 is a graph illustrating spectral efficiency performance of beam tracking for each type of beamforming according to the exemplary embodiment.

As shown in FIGS. 9, 10, and 11, the graphs illustrate FER, throughput, and spectral efficiency according to the techniques of the analog beamforming and hybrid beamforming. When the SNR is simulated in 5 dB increments from 0 dB to 40 dB, it may be confirmed that the case of applying the hybrid beamforming shows the improved performance compared to the case of applying the analog beamforming.

The next-generation mobile communication core technology obtained through these simulations is expected to greatly contribute to the improvement of mobile communication performance, export of terminals and parts, and network construction as well. Specifically, it is expected that the effects contributes to secure an edge in the standardization competition and to preoccupy the next-generation mobile communication market, improves technological independence and price competitiveness in the domestic mobile communications industry through transferring intellectual property rights such as next-generation mobile communication-related patents to industries, reduces the cost of the mobile communication industry by way of international cross-licensing of secured patents, and reduces royalty payments and replacing imports by securing core technologies of the next-generation mobile communication.

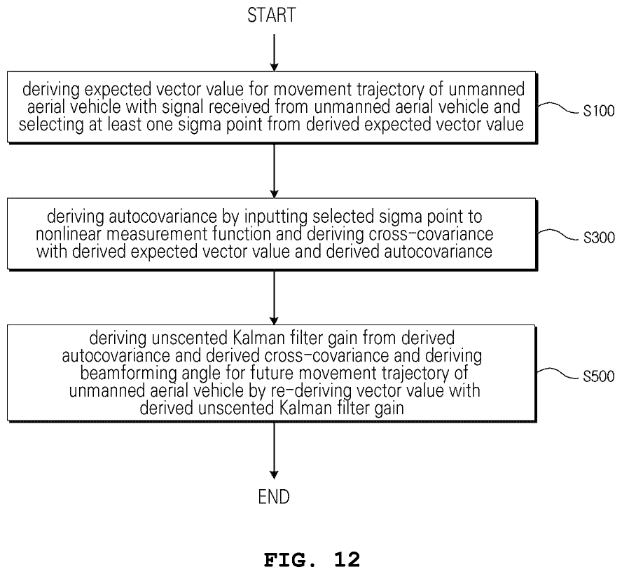

FIG. 12 is a flowchart illustrating a beam tracking method according to an exemplary embodiment.

As shown in FIG. 12, the beam tracking method according to the exemplary embodiment includes step S100 of preprocessing, step S300 of covariance derivation, and step S500 of beam estimation.

Step S100 of the preprocessing includes: deriving an expected vector value for a movement trajectory of an unmanned aerial vehicle with a signal received from the unmanned aerial vehicle; and selecting at least one sigma point from the derived expected vector value. In step S100 of the preprocessing, a next vector value may be derived from a previous vector value on the basis of a time at which the signal is received.

Step S300 of the covariance derivation includes: deriving an autocovariance by inputting the selected sigma point to a nonlinear measurement function; and deriving a cross-covariance with the derived expected vector value and the derived autocovariance. In step S300 of the covariance derivation, a Gaussian distribution for the vector value may be derived and a movement trajectory of the unmanned aerial vehicle may be derived with the derived Gaussian distribution.

Step S500 of the beam estimation includes: deriving an unscented Kalman filter gain from the derived autocovariance and the derived cross-covariance; and deriving a beamforming angle for a future movement trajectory of the unmanned aerial vehicle by re-deriving the vector value with the derived unscented Kalman filter gain.

Although the present disclosure has been described in detail through the exemplary embodiments above, those skilled in the art to which the present disclosure pertains will understand that various modifications can be made to the above-described exemplary embodiments without departing from the scope of the present disclosure. Therefore, the scope of the present disclosure should not be limited to the described exemplary embodiments, and should be determined not only by the scope of the claims to be described later, but also by any changes or modifications derived from the scope and equivalents of the claims.

What is claimed is:

1. An unscented Kalman filter-based beam tracking system, comprising:
a base station for performing beamforming to an unmanned aerial vehicle,
wherein the base station comprises:
a pre-processing unit configured to derive an expected vector value for a movement trajectory of the unmanned aerial vehicle with a signal received from the unmanned aerial vehicle, and select at least one sigma point from the derived expected vector value;
a covariance derivation unit configured to derive an autocovariance by inputting the selected sigma point to a nonlinear measurement function, and derive a cross-covariance with the derived expected vector value and the derived autocovariance; and
a beam estimation unit configured to derive a beamforming angle for a future movement trajectory of the unmanned aerial vehicle by deriving an unscented Kalman filter gain from the derived autocovariance and the derived cross-covariance.

2. The unscented Kalman filter-based beam tracking system of claim 1, wherein the vector value is a channel angle vector of the signal received from a location of the unmanned aerial vehicle.

3. The unscented Kalman filter-based beam tracking system of claim 1, wherein the pre-processing unit derives a next vector value from a previous vector value on the basis of a time at which the signal is received.

4. The unscented Kalman filter-based beam tracking system of claim 1, wherein the covariance derivation unit derives a Gaussian distribution for the vector value and derive the movement trajectory of the unmanned aerial vehicle with the derived Gaussian distribution.

5. The unscented Kalman filter-based beam tracking system of claim 1, wherein the beam estimation unit re-derives the vector value with the derived unscented Kalman filter gain.

6. An unscented Kalman filter-based beam tracking method, comprising:
a preprocessing step of deriving an expected vector value for a movement trajectory of an unmanned aerial vehicle with a signal received from the unmanned aerial vehicle, and selecting at least one sigma point from the derived expected vector value;
a covariance derivation step of deriving an autocovariance by inputting the selected sigma point to a nonlinear measurement function, and deriving a cross-covariance with the derived expected vector value and the derived autocovariance; and
a beam estimation step of deriving a beamforming angle for a future movement trajectory of the unmanned aerial vehicle by deriving an unscented Kalman filter gain from the derived autocovariance and the derived cross-covariance and re-deriving the vector value with the derived gain of the unscented Kalman filter.

7. The unscented Kalman filter-based beam tracking method of claim 6, wherein, in the pre-processing step, a next vector value is derived from a previous vector value on the basis of a time at which the signal is received.

8. The unscented Kalman filter-based beam tracking method of claim 6, wherein, in the covariance derivation step, a Gaussian distribution for the vector value is derived and the movement trajectory of the unmanned aerial vehicle is derived with the derived Gaussian distribution.
